(19) United States
(12) Patent Application Publication
(10) Pub. No.: US 2026/0350281 A1
(43) Pub. Date: Nov. 5, 2026

(54) LOCAL VARIATION-BASED LEAKAGE POWER ANALYSIS METHOD AND APPARATUS AND NON-TRANSITORY COMPUTER READABLE MEDIUM STORING COMPUTER PROGRAM THEREFOR

(71) Applicant: Samsung Electronics Co., Ltd., Suwon-si (KR)

(72) Inventors: Yoo Beom KIM, Suwon-si (KR); Seok Hoon Kim, Suwon-si (KR); Yu Jin Kim, Suwon-si (KR); Hyun-Seung Seo, Suwon-si (KR)

(73) Assignee: Samsung Electronics Co., Ltd., Suwon-si (KR)

(21) Appl. No.: 19/350,691

(22) Filed: Oct. 6, 2025

(30) Foreign Application Priority Data
Apr. 30, 2025 (KR) 10-2025-0057399

(51) Int. Cl. G06F 30/3308; G06F 30/323

(52) U.S. Cl. CPC G06F 30/3308; G06F 30/323

(57) ABSTRACT

Some example embodiments are directed to a local variation-based leakage power analysis method that is performed by a computing device. The method may include extracting a table including correction factors for leakage currents of a plurality of semiconductor devices from a circuit simulation model, extracting a plurality of device parameters of each of the plurality of semiconductor devices from a netlist, extracting process conditions of a target semiconductor device from a library file, and acquiring a first correction factor for leakage current of the target semiconductor device by referencing the plurality of device parameters and the process conditions in the table.

### CROSS-REFERENCE TO RELATED APPLICATION

This U.S. non-provisional application claims priority therefrom under 35 U.S.C. 119 from Korean Patent Application No. 10-2025-0057399 filed on Apr. 30, 2025, in the Korean Intellectual Property Office, the entire contents of which are herein incorporated by reference.

### BACKGROUND

Some example embodiments relate to a method for reflecting the effects of leakage power variation caused by local variation in a fabrication process in the design of semiconductor cells with minimal increase in the total design time an apparatus for performing the method, and a non-transitory computer-readable medium including a computer program.

In a semiconductor fabrication process, local variation may occur due to process deviations, even within the same chip. Such variations can cause circuit heating or performance degradation, and it is thus beneficial to consider these variations during the circuit design stage to ensure a relatively stable operation. For example, circuit simulation models (e.g., Simulation Program with Integrated Circuit Emphasis (SPICE)) may include correction factors reflecting the impact of local variation on leakage power. Based on these models, standard cells and memory cells are characterized to generate design data files (or design kits), which are commonly used for power analysis.

However, improvements or changes in the fabrication process may alter the characteristics of leakage current variation. To reflect such improvements or changes, the design data files may be updated and this may be a time consuming process and may increase the overall design time.

### SUMMARY

Some example embodiments of the present disclosure provide a method for calculating the leakage power of semiconductor cells corrected for local variation, without using additional simulations reflecting local variation, by extracting data that already reflects the effects of local variation from a design kit.

In addition, some example embodiments of the present disclosure provide a leakage power analysis method that reflects the influence of local variation and can be uniformly applied regardless of the type of semiconductor device or semiconductor cell.

Example embodiments of the present disclosure are not limited to those mentioned above, and other objectives not explicitly stated will be clearly understood by those skilled in the art based on the following description.

According to some example embodiments of the present disclosure, a local variation-based leakage power analysis method may be performed by a computing device. The method may include extracting a table including correction factors for leakage currents of a plurality of semiconductor devices from a circuit simulation model, extracting a plurality of device parameters of each of the plurality of semiconductor devices from a netlist, extracting process conditions of a target semiconductor device from a library file, and acquiring a first correction factor for leakage current of the target semiconductor device by referencing the plurality of device parameters and the process conditions in the table.

According to some example embodiments of the present disclosure, a local variation-based leakage power analysis apparatus may include a processor, and a computer readable memory storing computer readable instructions. The computer readable instructions, when executed by the processor, cause the processor to extract a table including correction factors for leakage currents of a plurality of semiconductor devices from a circuit simulation model, extract a plurality of device parameters of each of the plurality of semiconductor devices from a netlist, extract process conditions of a target semiconductor device from a library file, and acquire a first correction factor for leakage current of the target semiconductor device by referencing the plurality of device parameters and the process conditions in the table.

According to some example embodiments of the present disclosure, a non-transitory computer-readable medium storing a computer readable program, when the computer readable program instructions are executed by a processor, cause the processor to perform extracting a table including correction factors for leakage currents of a plurality of semiconductor devices from a circuit simulation model, extracting a plurality of device parameters of each of the plurality of semiconductor devices from a netlist, extracting process conditions of a target semiconductor device from a library file, and acquiring a first correction factor for leakage current of the target semiconductor device by referencing the plurality of device parameters and the process conditions in the table.

It should be noted that the example embodiments of the present disclosure are not limited to those described above, and other example embodiments will be apparent from the following description.

### BRIEF DESCRIPTION OF THE DRAWINGS

The above and other aspects and features of the present disclosure will become more apparent by describing example embodiments thereof in detail with reference to the attached drawings, in which:

FIG. 1 is a flowchart illustrating a method for designing a semiconductor integrated circuit according to some example embodiments of the present disclosure.

FIG. 2 is a flowchart illustrating a local variation-based leakage power analysis method according to some example embodiments of the present disclosure, as performed in a power analysis operation of FIG. 1.

FIG. 3 is a flowchart illustrating a local variation-based leakage power analysis method according to some example embodiments of the present disclosure.

FIG. 4 is a flowchart illustrating a local variation-based leakage power analysis method according to some example embodiments of the present disclosure.

FIG. 5 shows an uplift table according to some example embodiments of the present disclosure.

FIG. 6 illustrates a leakage current probability distribution according to some example embodiments of the present disclosure.

FIG. 7 is a block diagram illustrating a leakage power analysis apparatus according to some example embodiments of the present disclosure.

### DETAILED DESCRIPTION

Hereinafter, example embodiments of the present disclosure will be described in detail with reference to the attached drawings. Advantages and features of the present disclosure, and a method of achieving the advantages and features will become apparent with reference to example embodiments described later in detail together with the accompanying drawings. However, example embodiments of the present disclosure are not limited to the example embodiments as disclosed below, but may be implemented in various different forms. Thus, these example embodiments are set forth only to make the present disclosure complete, and to completely inform the scope of the present disclosure to those of ordinary skill in the technical field to which the present disclosure belongs, and the present disclosure is only defined by the scope of the claims.

The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure gist of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Unless otherwise defined, all terms including technical and scientific terms used herein have the same meaning as commonly understood by one of ordinary skills in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is directed to the purpose of describing some example embodiments only and is not intended to limit the present disclosure in any way. As used herein, the singular constitutes “a” and “an” are intended to include the plural constitutes as well, unless the context clearly indicates otherwise.

Additionally, in describing the components of the present disclosure, terms such as first, second, A, B, a, and b may be used. These terms are only used to distinguish one component from another component, and the nature, sequence, order, or number of the component are not limited by the term. It should be understood that when a component is described as being “connected,” “coupled,” or “combined” to another component, the component may be directly connected, coupled, or combined to another component, still another component may be “interposed” therebetween, and thus the component may be connected, coupled, or combined to another component via the still another component.

It will be further understood that the terms “comprise”, “comprising”, “include”, and “including” as used herein specify the presence of the stated features, operations, elements, and/or components, but do not preclude the presence or addition of one or more other features, operations, elements, components, and/or portions thereof.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

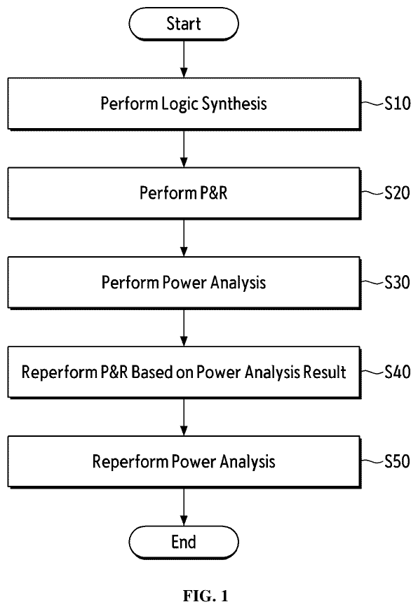

FIG. 1 is a flowchart illustrating a method for designing a semiconductor integrated circuit according to some example embodiments of the present disclosure. It is understood that additional operations can be provided before, during, and after the operations in FIG. 1, and some of the operations described below can be replaced or eliminated, for additional embodiments of the method. The order of the operations/processes may be interchangeable, or two or more operations can be performed simultaneously.

Referring to FIG. 1, the method for designing an integrated circuit may be for designing a layout for an integrated circuit, and may be performed using a tool for designing an integrated circuit. Here, the tool for designing an integrated circuit may be a program (e.g., software or application) including a plurality of computer readable instructions (e.g., instructions 13-2 in FIG. 7) executed by a processor (e.g., processor 11 in FIG. 7). Accordingly, the method for designing an integrated circuit may be referred to as a computer-implemented method for designing an integrated circuit.

In operation S10, a synthesis operation may be performed. For example, operation S10 may be performed by the processor using a synthesis tool. Here, “synthesis” refers to an operation of generating a netlist by converting input data for (or related to) an integrated circuit into a hardware form composed of logic gates, and may also be referred to as logic synthesis. The input data may define the behavior of the integrated circuit, for example, data defined at Register Transfer Level (RTL). A netlist may be generated from RTL code using a standard cell library and may be a gate-level netlist. In some example embodiments, RTL code may be provided to the synthesis tool as an input file, and the netlist may be output from the synthesis tool as an output file.

In operation S20, standard cells defining the integrated circuit may be placed and routed (P&R). For example, operation S20 may be performed by the processor using a P&R tool. The standard cells defining the integrated circuit may be placed according to the netlist using a standard cell library, and nets included in the placed standard cells may be routed to generate layout data for the integrated circuit. For example, the layout data may be in Graphic Design System II (GDSII) format. In some example embodiments, the netlist may be provided to the P&R tool as an input file, and the layout data may be output from the P&R tool as an output file.

Here, each net represents an equipotential in an equivalent circuit diagram of the integrated circuit and may correspond to an interconnection in the layout of the integrated circuit. One interconnection may correspond to a wiring structure including at least one metal layer and at least one via that are electrically connected. Accordingly, interconnections may electrically connect output pins and input pins of standard cells, and the standard cells may be routed by generating the interconnections.

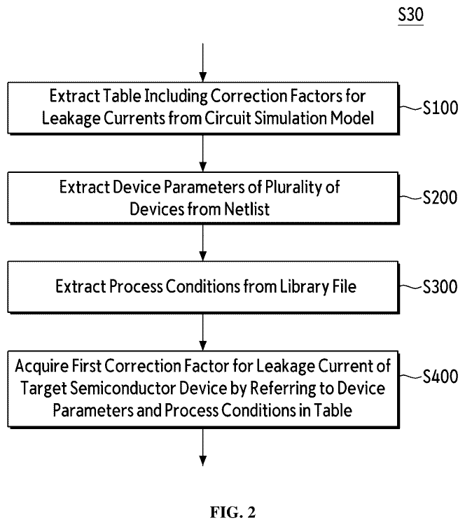

In operation S30, power analysis of the integrated circuit may be performed. For example, operation S30 may be performed by the processor using a power analysis tool (e.g., power analysis tool 12-1 in FIG. 7). In operation S30, which is the power analysis operation, it is beneficial to analyze leakage power. Leakage power refers to power loss that occurs regardless of whether switching occurs in a semiconductor device (e.g., a transistor). In other words, leakage power refers to the power consumed by a semiconductor device when the semiconductor device is not actively switching. Since the positions, types, and wiring structures of cells are determined during P&R, it is possible to perform relatively accurate power analysis reflecting actual physical characteristics of the integrated circuit. For example, even within the same chip, local variation may occur due to process deviations (e.g., during the manufacturing of the integrated circuit), and it is beneficial to analyze leakage power in consideration of local variation. A method for analyzing leakage power in consideration of local variation in operation S30 will be described later with reference to FIGS. 2 through 7.

In operation S40, P&R may be performed again (e.g., reperformed) based on the result of the power analysis. As P&R is performed again, layout data for the integrated circuit may be regenerated. For example, operation S40 may refer to the standard cell library and may be performed by the processor using a P&R tool. In some example embodiments, if the leakage power appears relatively higher (e.g., higher than a desired or given value), P&R may be performed again by, for example, replacing high-power cells with low-power cells and/or introducing a power gating technique. As P&R is performed again, layout data for the integrated circuit may be regenerated, and in operation S50, power analysis of the integrated circuit may be performed again (e.g., reperformed) using the regenerated layout data.

FIGS. 2 through 4 illustrate flowcharts of operations in a method performed by a leakage power analysis apparatus 10 depicted in FIG. 7. Therefore, in the following description, it may be understood that the operations are performed by the leakage power analysis apparatus 10 in FIG. 7, unless mentioned otherwise.

FIG. 2 is a flowchart illustrating a local variation-based leakage power analysis method according to some example embodiments of the present disclosure, in operation S30 of FIG. 1. It is understood that additional operations can be provided before, during, and after the operations in FIG. 2, and some of the operations described below can be replaced or eliminated, for additional embodiments of the method. The order of the operations/processes may be interchangeable, or two or more operations can be performed simultaneously. Referring to FIG. 2, in operation S100, a table including correction factors for the leakage currents of a plurality of semiconductor devices may be extracted from a circuit simulation model.

For example, the circuit simulation model may include a SPICE model, an IDDQ model, and a CIDDQ (Compact IDDQ) model. The SPICE model is a simulation model used to describe the electrical characteristics of semiconductor devices with relatively higher precision, enable circuit-level simulation by mathematically modeling the operation of transistors and predict characteristics such as voltage, current, delay, and power consumption under different conditions.

The IDDQ model is a type of SPICE model that analyzes a supply current in a quiescent state of a circuit. The IDDQ model is based on the principle that, under normal operation, a CMOS circuit draws a relatively smaller amount of current in the quiescent state, and may be used to detect potential defects such as shorts or leakage in a circuit by predicting this current through SPICE simulation. The CIDDQ model is a version (e.g., a simplified version) of the IDDQ model, in which the output results of the IDDQ model are converted into a tabular form. For example, the CIDDQ model may be obtained by executing the IDDQ model in advance under various conditions to precompute output, and storing the results as a lookup table.

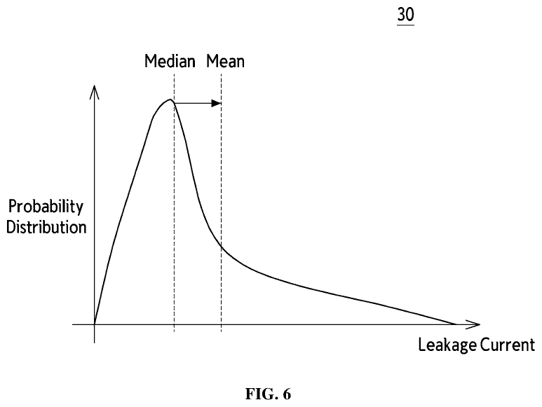

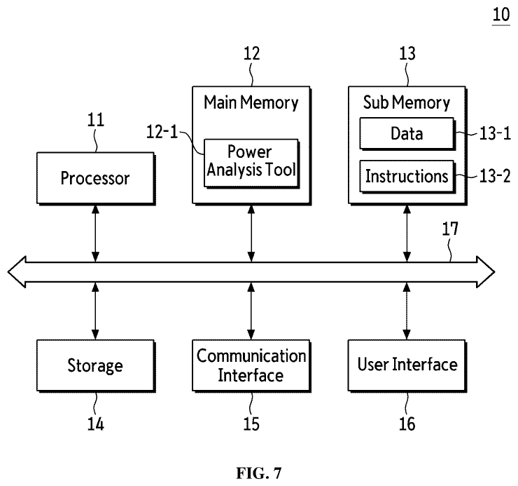

According to the circuit simulation model such as the SPICE model, IDDQ model, and CIDDQ model, uplift factors may be predicted as correction factors for compensating the effect of local variation on leakage current caused by process variation, depending on different parameters related to semiconductor devices (e.g., types of threshold voltage, number of fins, etc.) and different conditions related to the process of the semiconductor devices (e.g., process corner, voltage condition, and temperature condition indicating the type of the process). These uplift factors may be stored in the form of a table, which may be a lookup table that is referred to as an uplift table. The uplift table will be described later with reference to FIG. 5, and the relationship between uplift factors and leakage current will be described later with reference to FIG. 6.

In operation S200, a plurality of device parameters of each of the plurality of semiconductor devices (e.g., NMOS, PMOS, etc.) may be extracted from the netlist. As described above, the plurality of device parameters may include parameters related to the calculation of leakage current, such as threshold voltage type (e.g., super-low threshold voltage (slvt), low threshold voltage (lvt), regular threshold voltage (rvt), and high threshold voltage (hvt), the number of fins, and the like. In operation S300, process conditions (e.g., PVT conditions including process corner, voltage condition, and temperature condition) of a target semiconductor device for which a correction factor for leakage current is to be acquired may be extracted from a library file (e.g., a file in Liberty format).

Factors determining a correction factor (or uplift factor) will hereinafter be described as including process corner and temperature condition, but example embodiments are not limited thereto. Alternatively, depending on simulation results, voltage condition may also be used as a factor determining a correction factor for leakage current.

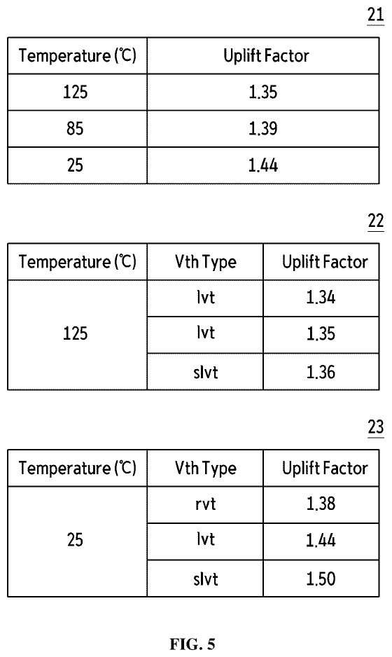

The circuit simulation model, netlist, and library file as described above may be included in a design kit (DK) or process design kit (PDK). Therefore, when the design kit or process design kit is updated, the influence of local variation may be simulated differently, and the uplift table may also be updated. Some example embodiments in which the uplift table is updated in accordance with the update of the design kit will be described later with reference to FIG. 4.

In operation S400, the plurality of device parameters and process conditions extracted via the simulation model may be referenced from the uplift table, and accordingly, a first correction factor (or uplift factor) for the leakage current of the target semiconductor device may be acquired or estimated. For example, the uplift table may function as a lookup table including uplift factors for types of semiconductor devices, device parameters, and process conditions.

Once the first correction factor (or uplift factor) for the target semiconductor device is acquired through operations S100, S200, S300, and/or S400, the actual leakage power of a target semiconductor cell may be calculated. For example, the library file referenced in operation S300 may include characterized leakage power of the target semiconductor cell. By multiplying the leakage current of the target semiconductor device by a cell-level compensation factor calculated using the first correction factor (or uplift factor) corresponding to the leakage current of the target semiconductor device, the actual (or estimated) leakage power of the target semiconductor cell reflecting local variation may be estimated. The leakage power of the target semiconductor cell may then be used to design a semiconductor circuit. The design may be utilized to manufacture a semiconductor circuit.

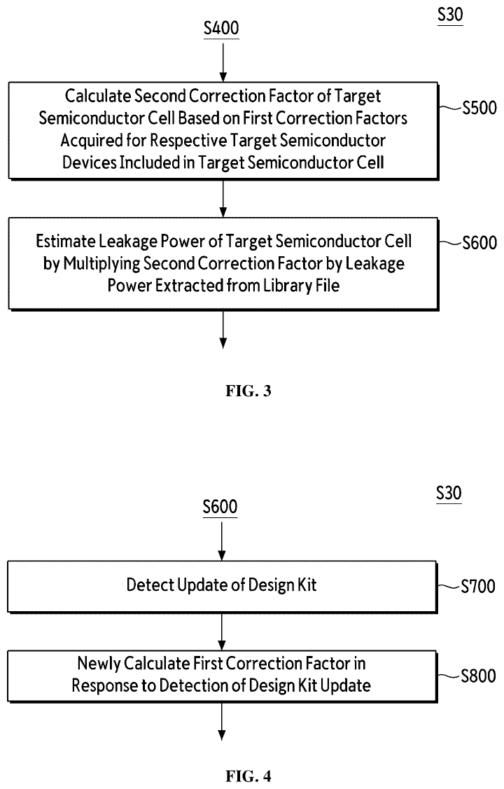

A method for calculating a cell-level correction factor for a semiconductor cell composed of semiconductor devices, and a method for estimating the leakage power of the semiconductor cell based on leakage power characterized in a library file will hereinafter be described with reference to FIG. 3. For the purposes of discussion, examples of a semiconductor cell include logic cells such as an inverter (INV), a 2-input NAND, and a 2-input NOR and memory cells such as SRAM, and each semiconductor cell may be composed of a plurality of semiconductor devices (e.g., NMOS, PMOS, etc.). For example, a CMOS inverter is composed of one NMOS and one PMOS.

FIG. 3 is a flowchart illustrating a local variation-based leakage power analysis method according to some example embodiments of the present disclosure. In some example embodiments, the operations in the flowchart of FIG. 3 may be performed after operation S400 of FIG. 3. It is understood that additional operations can be provided before, during, and after the operations in FIG. 3, and some of the operations described below can be replaced or eliminated, for additional embodiments of the method. The order of the operations/processes may be interchangeable, or two or more operations can be performed simultaneously. Referring to FIG. 3, in operation S500, based on the first correction factors (or uplift factors) acquired for one or more target semiconductor devices (e.g., NMOS and PMOS in the case of a CMOS inverter) included in a target semiconductor cell subject to leakage power analysis, a second correction factor for the leakage power of the target semiconductor cell may be calculated. Here, the second correction factor may also be referred to as a derate factor or a cell-level derate factor.

In some example embodiments, the derate factor of the target semiconductor cell may be calculated as an average of the uplift factors of the semiconductor devices constituting the target semiconductor cell. Alternatively, in some example embodiments, the derate factor of the target semiconductor cell may be calculated as an average of the uplift factors of predetermined representative semiconductor devices (e.g., one representative NMOS and one representative PMOS) among the semiconductor devices constituting the target semiconductor cell.

In operation S600, the leakage power of the target semiconductor cell may be extracted from a library file, and by multiplying the extracted leakage power by the derate factor acquired in operation S500, the leakage power of the target semiconductor cell may be estimated.

According to some example embodiments, uplift factors representing the influence of local variation due to leakage current may be acquired for respective semiconductor devices from a circuit simulation model, a netlist, and/or a library file, and a cell-level derate factor may be calculated from the acquired uplift factors. Accordingly, leakage power analysis reflecting the influence of local variation may be performed for all types of cells using the data (e.g., only the data) present in the circuit simulation model, the netlist, and/or the library file, regardless of cell type. In other words, since the method, according to some example embodiments, may not generate a design kit or a process design kit for each type of cell, the time required for the semiconductor circuit design (e.g., turnaround time (TAT)) may be reduced (e.g., may be significantly reduced).

FIG. 4 is a flowchart illustrating a local variation-based leakage power analysis method according to some example embodiments of the present disclosure. In some example embodiments, the operations in the flowchart of FIG. 4 may be performed after operation S600 of FIG. 3. It is understood that additional operations can be provided before, during, and after the operations in FIG. 4, and some of the operations described below can be replaced or eliminated, for additional embodiments of the method. The order of the operations/processes may be interchangeable, or two or more operations can be performed simultaneously. Referring to FIG. 4, in operation S700, an update of a design kit including a circuit simulation model, a netlist, and a library file may be detected. Here, the update of the design kit may indicate that the results related to the influence of local variation in the circuit simulation model have been updated.

In operation S800, in response to the update of the design kit being detected, first correction factors (or uplift factors) may be newly calculated (or recalculated) based on the updated circuit simulation model, netlist, and library file, and operations S500 and S600 in FIG. 3 may be performed again based on the newly calculated (or recalculated) first correction factors.

In some example embodiments of FIGS. 2 through 4, device parameters may be stored in a separate file after extraction or are stored in a library file. For example, the device parameters may be stored in a file that is separate (or different) from the library file that stores the process conditions. Alternatively, the device parameters may be stored in the library file that also includes the process conditions.

FIG. 5 shows an uplift table according to some example embodiments of the present disclosure. Referring to FIG. 5, table 21 shows uplift factors according to temperature, and tables 22 and 23 show uplift factors according to threshold voltage type at different temperatures. It is to be noted that tables 21, 22, and 23 in FIG. 5 are simplified for clear explanation, and may, in some example embodiments, include not only the uplift factors but also electrical characteristics (such as current and voltage) of simulated circuits, depending on the types of semiconductor devices, device parameters, process corners, and/or temperature conditions.

According to some example embodiments, an uplift table may be stored as a result of simulation via a circuit simulation model, as shown in FIG. 5, and since device parameters and process conditions are extractable from a netlist and a library file, respectively, uplift factors corresponding to the types of devices, device parameters, and process conditions can be obtained relatively easily.

FIG. 6 shows a leakage current probability distribution according to some example embodiments of the present disclosure. Referring to graph 30 of FIG. 6, the probability distribution of leakage current follows a log-normal distribution. For example, leakage current may follow a log-normal distribution depending on a threshold voltage, which causes local variation. When leakage current follows the log-normal distribution, the mean value of the leakage current may be expressed as a product of a specific (or desired or given) value and the median (e.g., the nominal current), and this specific (or desired or given) value corresponds to an uplift factor. An uplift factor calculated at the semiconductor cell level corresponds to the derate factor.

FIG. 7 is a block diagram illustrating a configuration of a leakage power analysis apparatus 10 according to some example embodiments of the present disclosure. FIG. 7 is a block diagram of a computing device that performs the local variation-based leakage power analysis methods described above with reference to FIGS. 2 through 6. Identical reference numerals denote identical components throughout this specification, and a description thereof will be omitted for the sake of brevity.

Referring to FIG. 7, the leakage power analysis apparatus 10 may include a processor 11, a main memory 12, a sub (or secondary) memory 13, a storage 14, a communication interface 15, a user interface 16, and a bus 17. The leakage power analysis apparatus 10 may be part of a semiconductor design system. The semiconductor design system may include different design and verification simulation programs. The leakage power analysis apparatus 10 may be implemented as a general-purpose computer or a special-purpose computer for semiconductor simulation.

The processor 11 may control the leakage power analysis apparatus 10, acquire uplift factors, calculate a derate factor, and estimate the leakage power of a semiconductor cell. The processor 11 may execute software running on the leakage power analysis apparatus 10. The software may include application programs, an operating system, device drivers, and the like. The processor 11 may execute an operating system stored in the main memory 12.

The processor 11 may execute various application programs based on the operating system. For example, the processor 11 may execute a power analysis tool 12-1 by executing instructions 13-2 stored in the sub memory 13. For example, the processor 11 may execute the power analysis tool 12-1 stored in the main memory 12. Accordingly, the processor 11 may perform a series of operations for leakage power analysis (e.g., operations S100 through S900 in FIGS. 2, 3, and 4). For example, the processor 11 may extract an uplift table, device parameters, and process conditions by using data 13-1 stored in the sub memory 13. Using the power analysis tool 12-1 stored in the main memory 12, the processor 11 may acquire the uplift factors of semiconductor devices forming a semiconductor cell, calculate the derate factor of the semiconductor cell, and estimate the leakage power of the semiconductor cell. The estimated leakage power may be utilized in designing a semiconductor circuit. The design may be utilized to manufacture a semiconductor circuit. The processor 11 may detect whether a design kit stored in the sub memory 13 has been updated. If the design kit has been updated, the processor 11 may perform power analysis again based on an updated uplift table.

The main memory 12 may be the working memory of the processor 11. The main memory 12 may store application programs, an operating system, device drivers, and the like, executed by the processor 11. For example, the main memory 12 may store the power analysis tool 12-1. The power analysis tool 12-1 may be an application program for analyzing the leakage power of a semiconductor cell. The power analysis tool 12-1 may be executed by the processor 11.

The main memory 12 may temporarily store data 13-1 or instructions 13-2, used by the processor 11, among the data 13-1 and instructions 13-2 stored in the sub memory 13. The main memory 12 may include at least one of volatile memory and nonvolatile memory. For example, the main memory 12 may include at least one of read-only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FeRAM), dynamic RAM (DRAM), static RAM (SRAM), synchronous DRAM (SDRAM), and the like.

The sub memory 13 may be a secondary memory of the leakage power analysis apparatus 10. The sub memory 13 may store data 13-1 and instructions 13-2. For example, the sub memory 13 may store results from a circuit simulation model, a netlist, and a library file. An uplift table included in the circuit simulation model, device parameters included in the netlist, and process conditions included in the library file may be delivered to the sub memory 13 as data 13-1 through the communication interface 15 or the storage 14.

The sub memory 13 may include a memory card (e.g., MMC, eMMC, SD, MicroSD), a hard disk drive (HDD), a solid-state drive (SSD), or an optical disk drive (ODD) or may include a NAND-type flash memory, but is not limited thereto. The sub memory 13 may also include a next-generation nonvolatile memory such as PRAM, MRAM, ReRAM, or FRAM, or NOR flash memory.

The storage 14 may include removable portable storage or memory device. For example, the data 13-1 and instructions 13-2 stored in the sub memory 13 may be transferred from the storage 14 to the sub memory 13. The storage 14 may be based on any one of various standards, such as Universal Serial Bus (USB) or Serial Advanced Technology Attachment (SATA).

The communication interface 15 may communicate with an external device via wired or wireless connections. For example, data 13-1 and instructions 13-2 may be stored in the sub memory 13 via the communication interface 15 from an external device. Alternatively, the data 13-1 and instructions 13-2 stored in the sub memory 13 may be transmitted to an external device through the communication interface 15. The communication interface 15 may be based on Ethernet or may be based on other wired or wireless computer networking technologies.

The user interface 16 may receive a command from a user to execute the power analysis tool 12-1. The user interface 16 may include various user input interface devices, such as a touch sensor, keyboard, mouse, pointing device, and the like. The user interface 16 may deliver the results of leakage power analysis according to some example embodiments of the present disclosure to a user. The user interface 16 may include various user output interface devices, such as a monitor and printer. The user interface 16 may display the results of leakage power analysis through a user output interface device.

The bus 17 may provide a network within the leakage power analysis apparatus 10. Through the bus 17, the processor 11, main memory 12, sub memory 13, storage 14, communication interface 15, and user interface 16 may be electrically connected to exchange data with one another.

According to some example embodiments of the present disclosure, since device parameters are extracted from a netlist used in a conventional library characterization process and information related to uplift factors is extracted from a SPICE model (e.g., IDDQ model or CIDDQ model), leakage power analysis for a semiconductor cell that reflects the influence of local variation can be performed without additionally simulating the influence of local variation or newly generate (or regenerate) a design kit or a process design kit. This may reduce (e.g., significantly reduce) the TAT required for semiconductor circuit design.

Various embodiments of the present disclosure and the effects according to those embodiments have been mentioned above with reference to FIGS. 1 to 7. The effects according to the technical idea of the present disclosure are not limited to the effects as mentioned above, and other effects not mentioned may be clearly understood by those skilled in the art from the above descriptions.

All the components that constitute the example embodiments of the present disclosure are described as being combined with each other or operating in combination with each other. However, the example embodiment of the present disclosure are not necessarily limited thereto. In other words, within the scope of the purpose of the present disclosure, all of the components may operate in a selective or desired combination manner of at least two thereof with each other.

Although the operations are shown as being executed in a specific order in the drawings, it should not be understood that the operations should be performed in the specific order as shown or in a sequential order or that all illustrated operations should be performed to obtain the desired result.

As described herein, any devices, systems, modules, portions, units, controllers, circuits, and/or portions thereof according to any of the example embodiments, and/or any portions thereof (including, without limitation, processor 11, main memory 12, sub memory 13, storage 14, communication interface 15, user interface 16, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A local variation-based leakage power analysis method performed by a computing device, comprising:
extracting a table including correction factors for leakage currents of a plurality of semiconductor devices from a circuit simulation model;
extracting a plurality of device parameters of each of the plurality of semiconductor devices from a netlist;
extracting process conditions of a target semiconductor device from a library file; and
acquiring a first correction factor for leakage current of the target semiconductor device by referencing the plurality of device parameters and the process conditions in the table.

2. The local variation-based leakage power analysis method of claim 1, wherein
the plurality of device parameters include threshold voltage type and a number of fins, and
the process conditions include at least one of process corner or temperature.

3. The local variation-based leakage power analysis method of claim 1, further comprising:
calculating a second correction factor for leakage power of a target semiconductor cell based on first correction factors acquired for one or more target semiconductor devices included in the target semiconductor cell; and
extracting leakage power of the target semiconductor cell from the library file, and estimating leakage power of the target semiconductor cell by multiplying the extracted leakage power by the second correction factor.

4. The local variation-based leakage power analysis method of claim 3, wherein the calculating of the second correction factor comprises calculating an average of the first correction factors acquired for the one or more target semiconductor devices.

5. The local variation-based leakage power analysis method of claim 1, further comprising:
detecting an update of a design kit including the circuit simulation model, the netlist, and the library file; and
in response to the update of the design kit being detected, recalculating the first correction factor based on the at least one of an updated circuit simulation model, an updated netlist, or an updated library file included in the updated design kit.

6. The local variation-based leakage power analysis method of claim 1, wherein the plurality of device parameters are stored in a file that is separate from the library file or are stored in the library file.

7. The local variation-based leakage power analysis method of claim 1, wherein the circuit simulation model is a CIDDQ model.

8. A local variation-based leakage power analysis apparatus, comprising:
a processor; and
a computer readable memory storing computer readable instructions,
wherein the computer readable instructions, when executed by the processor, cause the processor to:
extract a table including correction factors for leakage currents of a plurality of semiconductor devices from a circuit simulation model;
extract a plurality of device parameters of each of the plurality of semiconductor devices from a netlist;
extract process conditions of a target semiconductor device from a library file; and
acquire a first correction factor for leakage current of the target semiconductor device by referencing the plurality of device parameters and the process conditions in the table.

9. The local variation-based leakage power analysis apparatus of claim 8, wherein
the plurality of device parameters include threshold voltage type and a number of fins, and
the process conditions include process corner and temperature.

10. The local variation-based leakage power analysis apparatus of claim 8, wherein the computer readable instructions, when executed by the processor, further cause the processor to:
calculate a second correction factor for leakage power of a target semiconductor cell based on first correction factors acquired for one or more target semiconductor devices included in the target semiconductor cell; and
extract leakage power of the target semiconductor cell from the library file, and estimate leakage power of the target semiconductor cell by multiplying the extracted leakage power by the second correction factor.

11. The local variation-based leakage power analysis apparatus of claim 10, wherein the computer readable instructions, when executed by the processor, further cause the processor to calculate the second correction factor by calculating an average of the first correction factors acquired for the one or more target semiconductor devices.

12. The local variation-based leakage power analysis apparatus of claim 8, wherein the computer readable instructions, when executed by the processor, further cause the processor to:
detect an update of a design kit including the circuit simulation model, the netlist, and the library file; and
in response to the update of the design kit being detected, recalculate the first correction factor based on the at least one of an updated circuit simulation model, an updated netlist, or an updated library file included in the updated design kit.

13. The local variation-based leakage power analysis apparatus of claim 8, wherein the computer readable instructions, when executed by the processor, further cause the processor to reference the plurality of device parameters that are stored in a file that is separate from the library file or that are stored in the library file.

14. The local variation-based leakage power analysis apparatus of claim 8, wherein the circuit simulation model is a CIDDQ model.

15. A non-transitory computer-readable medium storing computer readable program instructions, wherein, when the computer readable program instructions are executed by a processor, cause the processor to perform:
extracting a table including correction factors for leakage currents of a plurality of semiconductor devices from a circuit simulation model;
extracting a plurality of device parameters of each of the plurality of semiconductor devices from a netlist;
extracting process conditions of a target semiconductor device from a library file; and
acquiring a first correction factor for leakage current of the target semiconductor device by referencing the plurality of device parameters and the process conditions in the table.

16. The non-transitory computer-readable medium of claim 15, wherein
the plurality of device parameters include threshold voltage type and a number of fins, and
the process conditions include at least one of process corner or temperature.

17. The non-transitory computer-readable medium of claim 15, wherein, when the computer readable program instructions are executed by the processor, the processor further performs:
calculating a second correction factor for leakage power of a target semiconductor cell based on first correction factors acquired for one or more target semiconductor devices included in the target semiconductor cell; and
extracting leakage power of the target semiconductor cell from the library file, and estimating leakage power of the target semiconductor cell by multiplying the extracted leakage power by the second correction factor.

18. The non-transitory computer-readable medium of claim 17, wherein, when the computer readable program instructions are executed by the processor, the processor further performs the calculating the second correction factor comprises calculating an average of the first correction factors acquired for the one or more target semiconductor devices.

19. The non-transitory computer-readable medium of claim 15, wherein, when the computer readable program instructions are executed by the processor, the processor further performs:
detecting an update of a design kit including the circuit simulation model, the netlist, and the library file; and
in response to the update of the design kit being detected, recalculating the first correction factor based on the at least one of an updated circuit simulation model, an updated netlist, or an updated library file included in the updated design kit.

20. The non-transitory computer-readable medium of claim 15, wherein the plurality of device parameters are stored in a file that is separate from the library file or are stored in the library file.
